(19) United States
(12) Patent Application Publication
(10) Pub. No.: US 2025/0284290 A1
(43) Pub. Date: Sep. 11, 2025

(54) ROBOT NAVIGATION

(71) Applicant: Alarm.com Incorporated, Tysons, VA (US)

(72) Inventors: Suyash Yeotikar, McLean, VA (US); Aditya Shiwaji Rasam, McLean, VA (US); Timon Meyer, Centreville, VA (US); Donald Gerard Madden, Columbia, MD (US); Glenn Tournier, Vienna, VA (US); Charles Bradley Rittler, III, Arlington, VA (US); Scott Almes, Laurel, MD (US); Narayanan Ramanathan, Chantilly, VA (US); Nikhil Ramachandran, Herndon, VA (US)

(21) Appl. No.: 19/062,377

(22) Filed: Feb. 25, 2025

Related U.S. Application Data
(60) Provisional application No. 63/563,152, filed on Mar. 8, 2024.

(51) Int. Cl. G05D 1/646; G05D 109/20; G05D 111/63

(52) U.S. Cl. CPC G05D 1/646; G05D 2109/20; G05D 2111/65

(57) ABSTRACT

Methods, systems, and apparatus, including computer programs encoded on computer storage media, for improving visual inertial odometry (VIO). One of the methods includes identifying two or more parameters of a robot; generating, using the two or more parameters, a multi-dimensional space; generating two or more configurations for the robot by sampling the multi-dimensional space; determining, for each of the two or more configurations, a visual inertial odometry (VIO) trajectory; generating, for each of the trajectories using the corresponding trajectory and a ground truth trajectory, (i) error data representing a difference of the corresponding trajectory from the ground truth trajectory and (ii) processing data representing processing metrics from the determination of the corresponding trajectory; selecting, using (i) the error data and (ii) the processing data, a configuration of the two or more configurations; and providing, to the robot, the selected configuration for navigating an area.

### CROSS-REFERENCE TO RELATED APPLICATION

This application claims the benefit of U.S. Provisional Application No. 63/563,152, filed Mar. 8, 2024, which is incorporated by reference.

### BACKGROUND

A monitoring system for a property can include various components including sensors, e.g., cameras, and other devices. For example, the monitoring system may use a drone that navigates around a property to perform one or more missions. The drone can capture sensor data and provide sensor data to a processing device to perform operations, such as visual inertial odometry.

### SUMMARY

This specification describes techniques, methods, systems, and other mechanisms for robot navigation that can result in improved visual inertial odometry (VIO). Robots can use parameters for navigation. The parameters can be for various components included in the robot, such as sensors and movement components, e.g., wheels or aerodynamic components such as a propeller.

In general, parameters can be floating points or integers. Numerous parameter combinations are possible, each resulting in better or worse performance, better or worse computation time, among others. Tuning each of the parameters by hand and determining values for operation can be liable to inaccuracies (e.g., selecting local optimizations, among others) as well as time-consuming. Additionally, for low-cost sensors, characteristics of the sensors may either not be available in datasheets or may be inaccurate (e.g., due to volatility in production tolerances). These parameters can be used during a robot VIO process, leading to inaccuracies in robot navigation.

The described methods, systems, and apparatus can cause a robot to use more accurate parameters. This can improve a resulting application of VIO, reduce tuning time compared to manual applications, allow for in-line optimizations or in the field optimizations, or a combination of two or more of these.

In some implementations, a drone provides image data and inertial data to a processing device. The processing device can select multiple sets of parameters to process the image data and inertial data for VIO. The processing device can generate a multi-dimensional space and select the multiple sets of parameters from ranges determined by an initial coarse scan of a parameter space or based on predetermined ranges. The processing device can compare multiple position estimations from a VIO system operating on two or more different sets of parameters. The processing device can select a parameter set, based on comparing one or more position estimations, for processing subsequent image and inertial data, e.g., from a drone requesting VIO processing using obtained sensor data.

In general, one innovative aspect of the subject matter described in this specification can be embodied in methods that include the actions of identifying two or more parameters of a robot; generating, using the two or more parameters, a multi-dimensional space, each dimension of the multi-dimensional space corresponding to a parameter of the two or more parameters; generating two or more configurations for the device by sampling the multi-dimensional space, each configuration of the two or more configurations including values for each of the two or more parameters, at least some first values for a first configuration from the two or more configurations different from corresponding second values for a second configuration from the two or more configurations; determining, for each of the two or more configurations, a visual inertial odometry (VIO) trajectory; generating, for each of the trajectories using the corresponding trajectory and a ground truth trajectory, (i) error data representing a difference of the corresponding trajectory from the ground truth trajectory and (ii) processing data representing processing metrics from the determination of the corresponding VIO trajectory; selecting, using (i) the error data and (ii) the processing data, a configuration of the two or more configurations; and providing, to the robot, the selected configuration for navigating an area

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, generating the two or more configurations includes: performing a first sampling of the multi-dimensional space; identifying, using parameter values from the first sampling, a sub-region of the multi-dimensional space; and performing a second sampling of the sub-region of the multi-dimensional space.

In some implementations, generating the two or more configurations includes: converting a value of the two or more configurations to match a valid parameter type. In some implementations, prior to generating the two or more configurations, actions include: identifying valid ranges of the multi-dimensional space within which to sample for generating the two or more configurations. In some implementations, sampling the multi-dimensional space includes Latin hypercube sampling (LHS).

In some implementations, sampling the multi-dimensional space includes Orthogonal LHS. In some implementations, prior to sampling the multi-dimensional space, actions include: dividing the multi-dimensional space non-uniformly. In some implementations, dividing the multi-dimensional space non-uniformly includes: dividing the multi-dimensional space using a logarithmic scale.

In some implementations, the error data representing the difference of the corresponding trajectory from the ground truth trajectory includes one or more of Absolute Trajectory Root Mean Square Error (ATE) or Relative Pose Error (RPE). In some implementations, selecting the configuration of the two or more configurations includes: identifying an intersection between performance values of a first metric and performance values of a second metric, where the performance values of the first metric and the performance values of the second metric are generated based on determining the VIO trajectory for each of the two or more configurations; and selecting, from the intersection, the configuration of the two or more configurations.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. For example, VIO processes can be used in robotics to more accurately estimate a position of a robot relative to a starting point. VIO processes can use images and Inertial Measurement Unit (IMU) data and sensor fusion algorithms, e.g., Kalman Filter, Particle filter, among others, to fuse information from sensors to estimate a position, velocity, or orientation of a robot, such as a drone. The VIO processes can include one or more algorithms that operate according to one or more parameters. The systems and methods described in this specification can more accurately tune parameters compared to other systems, e.g., to minimize computation time, improve affordability, improve performance based on characteristics of sensors, improve a VIO algorithm itself, or a combination of two or more of these. By improving the accuracy of the parameters, the systems and methods described in this specification can improve robot performance compared to other systems, e.g., in which a robot without the improved parameters might cause damage to a property or individuals based on inaccurate position measurements.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram showing an example of an environment for improved visual inertial odometry.

FIG. 2 is a flow diagram illustrating an example of a process for improved visual inertial odometry.

FIG. 3 is a diagram illustrating an example of an environment for monitoring a property.

Like reference numbers and designations in the various drawings indicate like elements.

### DETAILED DESCRIPTION

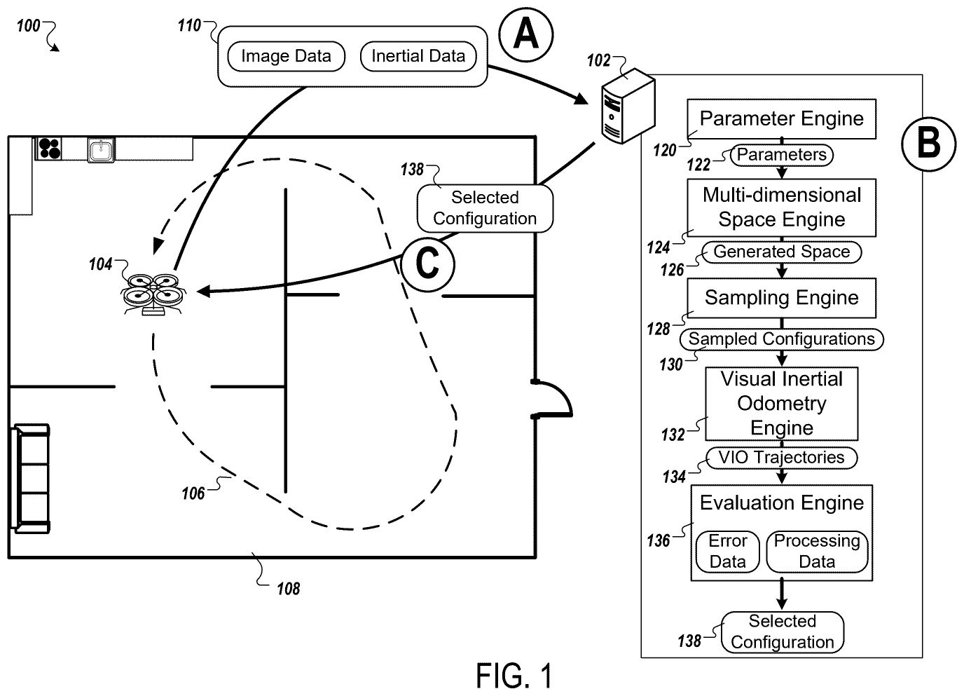

FIG. 1 is a diagram showing an example of an environment 100 for improved visual inertial odometry. The environment 100 includes a system 102 and a robot 104 that are communicably connected, e.g., using a network. The robot 104 can navigate, e.g., along a trajectory 106, at the property 108. The robot 104 can be any appropriate type of robot, e.g., an aerial drone or ground robot. In general, the system 102 can generate a selected configuration 138, e.g., optimal configuration or more optimal configuration, for the robot 104 that includes an estimate of optimal processing parameters for generating position, velocity, orientation, or a combination of these, of the robot 104 based on processing input data, e.g., image or inertial data or both captured by the robot 104. Processing that uses the processing parameters can include odometry algorithms, such as visual inertial odometry (VIO), or related processes, such as fusing information—e.g., Kalman filtering, particle filtering, or a combination of these.

Different parameters can result in different processing outcomes—e.g., greater or lesser accuracy, greater or lesser computational efficiency, greater or lesser computation time, or a combination of two or more of these. The system 102 can optimize the parameters to improve one or more of the different processing outcomes.

In stage A, shown in FIG. 1, the system 102 obtains robot data 110 from the robot 104. The robot data 110 includes image data and inertial data. Other examples can include other appropriate types of data. In some cases, the robot data 110 is collected by one or more sensors onboard the robot 104 based on the robot 104 traversing at least a portion of the trajectory 106. The robot data 110 can be collected by one or more sensors onboard the robot 104 based on the robot 104, or another robot, traversing one or more trajectories, e.g., while operating on one or more flights or runs.

In stage B, a parameter engine 120 of the system 102 identifies parameters 122 of the robot 104. The parameters 122 can include one or more parameters that are used in generating, processing, or both, input data for generating one or more of position, velocity, or orientation of the robot 104. For example, the parameters 122 can include a number of features for feature detection and matching, a size of a feature window, a threshold for feature detection, IMU noise, or a combination of these. In some examples, the parameters can be parameters for a sensor included in the robot 104, e.g., a motion sensor, a camera, or another appropriate type of sensor. Parameters can include image update noise parameters, parameters for convergence termination criteria, or a combination of both. In some cases, other parameters can be used—e.g., parameters suitable for a given algorithm such as VIO or other algorithm.

Using the parameters 122, a multi-dimensional space engine 124 of the system 102 can generate a space 126. The generated space 126 can represent a parameter space where each dimension corresponds to a parameter of the parameters 122. In some cases, the generated space 126 can be a hypercube. In some cases, the multi-dimensional space engine 124 can generate a space using one or more parameter constraints; relationships among parameters—e.g., between predetermined parameters if any parameters are predetermined; or both. In some cases, the multi-dimensional space engine 124 can generate a space representing one or more parameters as independent parameters—e.g., using a corresponding space element, such as a hypercube.

Using the generated space 126, a sampling engine 128 of the system 102 can sample one or more configurations 130. The sampled configurations 130 can include one or more values representing processing parameter values for generating position, velocity, or orientation of the robot 104 based on processing input data. To sample a configuration, the sampling engine 128 can generate a sample configuration for the robot 104 by selecting a combination of parameters from the generated space 126 for the robot. The sampling engine 128 can generate multiple different configuration samples for the robot 104.

In some implementations, the sampling engine 128 of the system 102 samples using one or more sampling methods. For example, the sampling engine 128 can use Latin hypercube sampling (LHS). The sampling engine 128 can use Orthogonal LHS—e.g., dividing the generated space 126 into equally probable spaces. In some cases, the system 102 can generate the sampled configurations 130 by sampling a space uniformly. In some cases, the system 102 can sample a space uniformly by dividing the space, such as a hypercube, into grid elements. In some cases, the system 102 can use LHS to uniformly divide a space.

For any particular robot, the impact of parameters from a sample configuration on a processing result—e.g., accuracy of generated trajectory, processing time, or processing requirements—can be non-linear. As a result, a slight change in one parameter can significantly impact the performance of processing, e.g., VIO. To account for this, the system 102 can generate a sample configuration that is specific to a particular robot. Although the system 102 can generate sample configurations for multiple robots of the same type, e.g., with the same brand and model, given variations in the components of the robots, such as variations in the sensors, a particular sample configuration can cause a different performance impact for one of the robots of the same type compared to another. As a result, in some implementations, the system 102 or a combination of systems can perform one or more operations described in reference to FIG. 1 multiple times for different robots from the robots of the same type.

In some implementations, the sampling engine 128 samples values coarsely over a large parameter space—e.g., before subsequent sampling over a portion of the large parameter space determined based on coarsely sampled values. Ranges of values covered by a space can be configured according to datasheet or sensor characteristics. For example, the system 102 can use Orthogonal LHS to sample parameter values coarsely over a large parameter space and use those sampled parameters in processing, e.g., VIO processing, to determine a parameter region in multi-dimensional space that results in less deviation from a ground truth trajectory, less processing requirements, less processing time, or a combination of two or more of these. A ground truth trajectory can represent the actual trajectory traversed by a robot—e.g., the ground truth trajectory can include a collection of coordinates in two or three dimensions. In some cases, a trajectory can be represented by coordinates in two or three dimensions, a continuous time domain using splines or other analytic functions, or a combination of these, among others. A motion capture system can capture actual locations of a robot over time while that robot captures sensor data for VIO. The captured sensor data can be used as the input for which multiple configurations of VIO parameters are tested to determine which configuration produces a trajectory that most matches the ground truth trajectory traversed by the robot. In some examples, the ground truth trajectory can represent a trajectory traversed by the robot using sensors with a higher accuracy than sensors used for VIO, the latter of which can require fewer computational resources.

The system 102 can use parameter regions determined using a first, coarse, sampling of parameter space as ranges for sampling that is more accurate compared to the first, coarse, sampling. By first sampling more coarsely, and following with a more accurate sampling of regions of space with good performance—e.g., one or more performance metrics satisfying one or more thresholds-locally optimal parameter configurations can be avoided in favor or global optimal configurations. Ranges for more accurate sampling can be determined using one or more axis center points of the parameter regions determined to be good for processing—e.g., regions where parameter values, when used in VIO, produce trajectories that satisfy a similarity threshold compared to a ground truth trajectory. Extremes of ranges for more accurate sampling can be determined by multiplying or dividing the center points by one or more factors.

In some implementations, the system 102 divides the space non-uniformly, e.g., instead of or in addition to uniform sampling. For example, the system 102 can divide the generated space 126 using a logarithmic scale. The sampling engine 128 can then sample over a region to uniformly sample in the non-uniformly divided space—e.g., sampling every unit along a logarithmic parameter axis. In this way, the sampling engine 128 can generate samplings that are skewed towards portions of ranges in the generated space 126 because of the initial non-uniformly divided space—e.g., more samplings per unit of parameter space in lower value regions by using uniform sampling on a logarithmic scale compared to other processes that solely use uniform samplings.

In some implementations, distributions or other factors are used to adjust a uniform sampling. For example, a Gaussian distribution can be used to concentrate sampling by the sampling engine 128 to a center region of a range in the generated space 126.

In some implementations, the sampling engine 128 samples values of a first type and then converts the sampled value to type that matches an expected type for a corresponding odometry process. For example, some parameters in a process, such as VIO, might require integer or whole number types. The sampling engine 128 can sample values as a floating type value and then convert the sampled float values to integer values to be stored in the sampled configurations 130. In this way, the sampled configurations 130 can include values in formats to be used directly in subsequent processes, such as VIO.

In some implementations, the system 102 determines regions, e.g., ranges, within the generated space 126 to limit a space for sampling. For example, the generated space 126 can be limited to regions of parameter values for which a corresponding process using the parameter values operates in a valid way—e.g., does not exceed computation time threshold, does not cause errors, among others. To determine the regions, the system 102 can perform odometry processing, such as VIO, using parameter values across a first range. Determining regions of parameter space for which parameters operate in a valid way can include determining if a parameter in a given region satisfies one or more operational criteria. The one or more operational criteria can indicate whether or not parameter values would cause a robot using them operate in a valid way. Invalid operation of a robot could include navigation errors, processing time outs, memory overflow, or a combination of these. As a result, operation in a valid way can reduce a likelihood that the robot will have navigation errors, processing time outs, memory overflow or a combination of these. For parameter values that cause invalid robot operation, the system 102 can restrict the generated space 126 using ranges to remove those parameter values such that they will not be sampled or will be less likely to be sampled. In some cases, expert knowledge can be used to set ranges of parameter values—e.g., to within a plus or minus percentage or value of a known, or set of known, parameter values that have been determined to not cause invalid robot operation.

Using the sampled configurations 130, a VIO engine 132 of the system 102 can generate one or more VIO trajectories 134. The VIO trajectories 134 can indicate a predicted path of a robot, such as the robot 104, based on input data—e.g., image or inertial data captured by a robot or simulated. Each predicted trajectory of the VIO trajectories 134 can be generated using a given configuration of parameters from the sampled configurations 130.

The VIO engine 132 or another component of the system 102 can determine differences between at least some of the two or more predicted trajectories. Differences between two or more predicted trajectories can include differences in the trajectories themselves, differences in the processing requirements or time of generating the trajectories, or both. The differences can be based on the different configuration of parameters used to generate each trajectory. Differences can include processing differences—e.g., the time for VIO processes to complete or processing resources, such as computer RAM, required—or spatial differences—e.g., variations in the path of a robot represented by each of the VIO trajectories 134.

The VIO engine 132 can use any appropriate input data. In some cases, the robot data 110 is used as input data to generate the VIO trajectories 134. In some cases, other data is used to generate the VIO trajectories 134. Data used as input data can include data that was previously obtained from a robot that operated at a property, data that was generated synthetically by a system—e.g., based on a simulation of robot movement, or a combination of both. The input data can include image or inertial data, such as image or inertial data captured by the robot 104.

An evaluation engine 136 of the system 102 generates error data and processing data. The error data can represent spatial differences between a given predicted trajectory of the VIO trajectories 134 and a ground truth trajectory. In some cases, the ground truth trajectory can be simulated or captured using a motion capture system, such as a system that captures the motion of a robot and determines the trajectory of the robot using one or more sensors—e.g., calibrated cameras. In some cases, the ground truth trajectory can be obtained from sensors have higher accuracy than VIO, such as a motion capture system. The processing data refers to differences in time or processing requirements used in generating the VIO trajectories 134—e.g., where the evaluation engine 136 can determine which processing, that resulted in a generated trajectory of the VIO trajectories 134, was most efficient or took the least amount of time, among other metrics.

In some cases, a ground truth trajectory can be generated using one or more estimation algorithms or sensors. For example, the system 102 can generate a ground truth trajectory using Iterative Closest Point (ICP) odometry and sensor data from sensors, such as Lidars or Time Of Flight sensors. In some cases, the ground truth trajectory can be obtained by combining two or more algorithms each using a same or different sensor suite. For example, the system 102 can combine a Simultaneous Localization and Mapping (SLAM) algorithm with an odometry process, where inaccuracies in odometry can be minimized using loop closures in SLAM and hence can be used to generate, by the system 102, a ground truth trajectory.

In some cases, VIO configuration selection and ground truth generation can be combined or be an iterative process. For example, a ground truth trajectory can be generated using ICP odometry. The accuracy of the ICP generated ground truth can depend on VIO as it can be used as an initial guess for ICP algorithm at every location. VIO used with ICP can be based on an initial configuration or a last best working version over one or more iterations.

In some cases, a selection of a best configuration file for VIO used in ground truth generation can be iterative. For example, a first iteration can be based on an initial configuration file for VIO. The initial configuration can have some drift, e.g., 20% drift. ICP odometry or ground truth generation with the initial configuration file can have some drift, e.g., 10% drift.

Using a ground truth trajectory generated from the initial configuration, parameters can be evaluated and more optimal parameters selected for a second configuration. The second configuration can result in less drift, or error compared to the first configuration. Using the second configuration, the system 102 can regenerate ICP odometry or ground truth data that is more accurate—e.g., is more similar to an actual route of a robot-compared to the first configuration. This improved ground truth data can be used in subsequent evaluation, e.g., to improve VIO, iteratively improve corresponding ground truth trajectories and subsequent VIO, or both.

The iterative process can terminate in response to one or more accuracy thresholds for ground truth trajectory error being satisfied—e.g., an estimated ground truth trajectory compared to a previous estimated ground truth trajectory where a threshold indicates an amount of change between iterations or compared to ground truth generated using another generation method. For example, if a change is less than one percent, or some other value, the process can terminate and a corresponding ground truth trajectory can be used to determine one or more parameter values as described in this document.

The evaluation engine 136 of the system 102 selects a configuration 138, e.g., an optimal configuration. The evaluation engine 136 can select the configuration 138 as the configuration which produced a VIO trajectory that was within a threshold accuracy of a ground truth trajectory, was within a top performing set in one or more performance metrics, or a combination of these.

In some implementations, one or more metrics are used to evaluate processing, e.g., processing using VIO. The one or more metrics can include: Absolute Trajectory Root Mean Square Error (ATE); Relative Pose Error (RPE); smoothness metrics—e.g., to determine an output trajectory is smooth; Normalized innovation squared error (NIS)—e.g., over a trajectory for Kalman Filter based VIO; computation time; or CPU usage. Metrics can include velocity—e.g., of a robot; rotation root mean squared error—e.g., indicating an error in positioning or orientation of a robot; or average re-projection error of features in an image—e.g., errors between known locations of features and locations of features determined using images from a robot. The evaluation engine 136 can use one or more of these metrics, e.g., as performance metrics, when selecting a configuration from the sample configurations.

In some implementations, the evaluation engine 136 selects the configuration 138 using a divided metric space. For example, one configuration might not perform best across all metrics requiring a trade-off determination. The evaluation engine 136 can divide the multi-dimension space into sections, e.g., good, mediocre, and bad performances. In some cases, more or fewer divisions are generated. Based on user provided thresholds or default thresholds of the system 102, the evaluation engine 136 can identify which configurations belong in which section of the metric space. The evaluation engine 136 can then select from the divided multi-dimension space, e.g., from one or more sections for good performances, the configuration 138.

In some cases, the sections are metric dependent—e.g., for a first metric, a first configuration is optimal but for a second metric the first configuration is the least optimal. For example, the evaluation engine 136 can generate datasets for each metric identifying a set of one or more configurations—e.g., configurations in one or more sections of metric space. In some cases, the evaluation engine 136 can generate a set of top configurations, e.g., ten best performing, for each metric. The evaluation engine 136 can identify an intersection of the multiple sets of top configurations and choose the configuration 138 from the intersection set. If multiple sample configurations exist in the set of top configurations, then the evaluation engine 136 can select a specific metric, or set of metrics, to maximize and choose the configuration 138 for which the given metric or set of metrics is maximized.

In some implementations, a weighted summation is used to determine the configuration 138. For example, the evaluation engine 136 can determine one or more metric values for each of the VIO trajectories 134. Using the determined metric values and a weighted summation, the evaluation engine 136 can select the configuration 138 as the configuration that results in a lowest or highest weighted summation value. In cases of ties, or cases where summations are within a threshold value distance of one another, the evaluation engine 136 can select a metric to minimize or maximize and choose the configuration 138 as the configuration that results in the more optimal of the selected metric.

In some cases, weighted sums can be equal to a predetermined value, e.g., one. For example, metrics can include absolute trajectory error (ATE), e.g., root mean squared error (RMSE), processing unit usage, or both. In some cases, ATE RMSE might be more important to minimize compared to processing unit usage (e.g., usage by a CPU). Relative importance of metrics can vary and suitable weighting can be used to represent various importance values. In some cases, the system 102 can assign a weight of 0.7 to RMSE and 0.3 to CPU usage. For a configuration where RMSE is 0.10 m and CPU usage is 70% and another configuration where RMSE is 0.30 m and CPU usage is 40%, weighted summations, generated by the system 102, can result in the following: e.g., for the first configuration a weighted sum can be represented as, 0.7*0.1+0.3*0.7=0.28, where 0.28 can represent a final summation value or score. Percentages can be converted to decimal values. For the second configuration a weighted sum can be represented as, 0.7*0.3+0.3*0.4=0.33, where 0.33 can represent a final summation value or score. In some cases, a score can be minimized and thus, the system 102 can select the first configuration over the second configuration.

In stage C, the system 102 provides the configuration 138 to the robot 104. The configuration 138 can be a representation of the selected configuration 138 generated for transmission along a communication channel to the robot 104.

The configuration 138 can be used by the robot 104. For example, the configuration 138 can be used by the robot 104 during navigation—e.g., to affect how sensor data is processed for navigation. In some cases, the configuration 138 is used to improve accuracy of a predicted location of the robot over time. Parameters of the configuration 138 can indicate how noise of an inertial measurement unit (IMU) can effect fusion of inertial measurements for motion estimation, e.g., in VIO. Selecting optimal, or more optimal, values for parameters, such as noise parameters, can improve motion estimates compared to initial or other prior parameter values or values selected using other techniques. In some cases, the configuration 138 includes parameters affecting other aspects of navigation. The optimal, or more optimal, values selected for these parameters using the techniques described can similarly improve navigation. In some cases, optimal feature detection parameters can help ensure valid features are able to be tracked, e.g., by the system 102, across multiple lighting conditions within or across datasets—e.g., where non-optimal parameter values can reduce the likelihood of correctly detecting one or more features where features can be detected using sensor data captured by the robot 104.

The use by the robot 104 can include evaluation of the configuration 138, e.g., during runtime. Evaluation of the configuration 138 can be used as feedback for subsequent parameter selection—e.g., to increase a likelihood of selecting parameters similar to well performing parameters and to decrease a likelihood of selecting parameters similar to not well performing parameters. The system 102 can determine whether parameters are well performing by comparing values indicating an evaluation of a configuration to one or more thresholds and determining whether the values satisfy or do not satisfy the one or more thresholds. If the parameters satisfy the one or more thresholds, the system 102 can determine that the parameters are likely well performing and determine to skip additional parameter selection, e.g., for the robot to which the parameters apply. The system 102 can continue to determine parameters for other robots.

In some cases, selecting subsequent parameters that are similar to well performing parameters can include adding a metric indicating a difference in value between a given set of parameter values and the one or more well performing parameters—e.g., where a low difference value indicates a higher degree of similarity with well performing parameters and therefore a higher likelihood of selection. In some cases, use of the configuration 138 can result in metrics, such as number of collisions, errors, or other values based on activity of the robot 104 after using the configuration 138 for navigation. Data indicating activity of the robot 104 that can be provided to the system 102 for subsequent parameter selection—e.g., to select subsequent parameters, for the robot 104 or another robot, more similar to the configuration 138 if performance using the configuration 138 satisfies one or more performance criteria.

The system 102 is an example of a system implemented as computer programs on one or more computers in one or more locations, in which the systems, components, and techniques described in this specification are implemented. The network (not shown), such as a local area network (“LAN”), wide area network (“WAN”), the Internet, or a combination thereof, connects the system 102 and the drone 104. The system 102 can use a single computer or multiple computers operating in conjunction with one another, including, for example, a set of remote computers deployed as a cloud computing service.

The system 102 can include several different functional components, including the parameter engine 120, the multi-dimensional space engine 124, the sampling engine 128, the visual odometry engine 132, and the evaluation engine 136. Any functional component or a combination of two or more functional components, can include one or more data processing apparatuses, can be implemented in code, or a combination of both. For instance, each of the functional components can include one or more data processors and instructions that cause the one or more data processors to perform the operations discussed herein.

The various functional components of the system 102 can be installed on one or more computers as separate functional components or as different modules of a same functional component. For example, the parameter engine 120 and the multi-dimensional space engine 124 of the system 102 can be implemented as computer programs installed on one or more computers in one or more locations that are coupled to each through a network. In cloud-based systems for example, these components can be implemented by individual computing nodes of a distributed computing system.

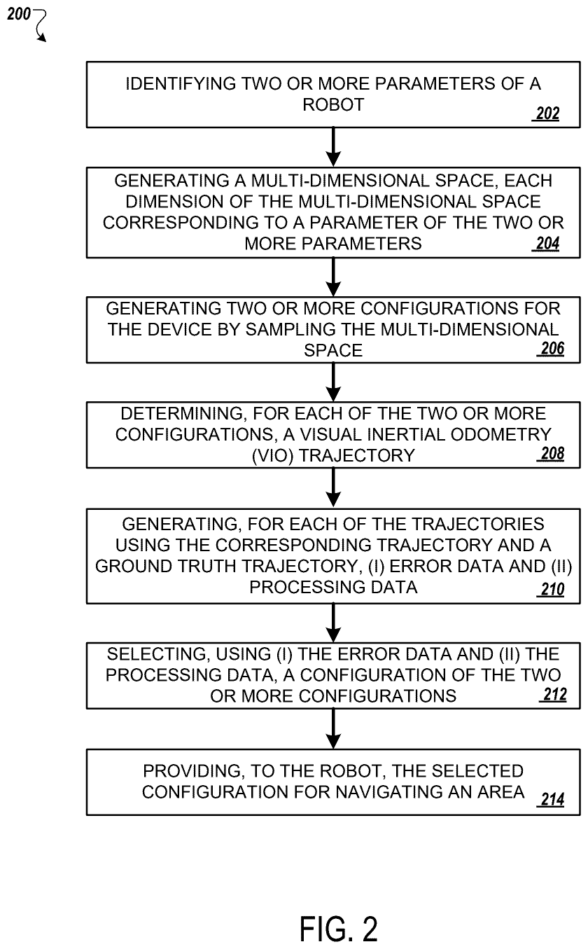

FIG. 2 is a flow diagram illustrating an example of a process 200 for improved visual inertial odometry. For example, the process 200 can be used by the system 102 from the environment 100.

The process 200 includes identifying two or more parameters of a robot (202). For example, the parameter engine 120 of the system 102 of FIG. 1, can identify parameters 122 of the robot 104. The parameters 122 can include one or more parameters that are used in generating, processing, or both, input data for generating one or more of position, velocity, or orientation of the robot 104. The parameters 122 can be parameters used by the robot as part of visual inertial odometry.

The process 200 includes generating a multi-dimensional space, each dimension of the multi-dimensional space corresponding to a parameter of the two or more parameters (204). For example, the multi-dimensional space engine 124 of the system 102 can generate the generated space 126. In some implementations, instead of generating the multi-dimensional space, the process 200 can access an existing multi-dimensional space. This can occur when the system performed at least some of the operations of the process 200 for the robot previously. The system can maintain the multi-dimensional space for the robot and access that maintained space during later execution of the process 200.

The process 200 includes generating two or more configurations for the device by sampling the multi-dimensional space (206). For example, the sampling engine 128 of the system 102 can sample one or more configurations 130.

The process 200 includes determining, for each of the two or more configurations, a visual inertial odometry (VIO) trajectory (208). For example, the VIO engine 132 of the system 102 can generate one or more VIO trajectories 134.

The process 200 includes generating, for each of the trajectories using the corresponding trajectory and a ground truth trajectory, (i) error data and (ii) processing data (210). For example, the evaluation engine 136 of the system 102 can generate error data and processing data. In some examples, the evaluation engine 136 might generate one type of data, e.g., either error data or processing data but not necessarily both, or both types of data might be included in the same data, e.g., the processing data might include the error data.

The process 200 includes selecting, using (i) the error data and (ii) the processing data, a configuration of the two or more configurations (212). For example, the evaluation engine 136 of the system 102 can select the configuration 138.

The process 200 includes providing, to the robot, the selected configuration for navigating an area (214). For example, the system 102 provides the configuration 138 to the robot 104.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

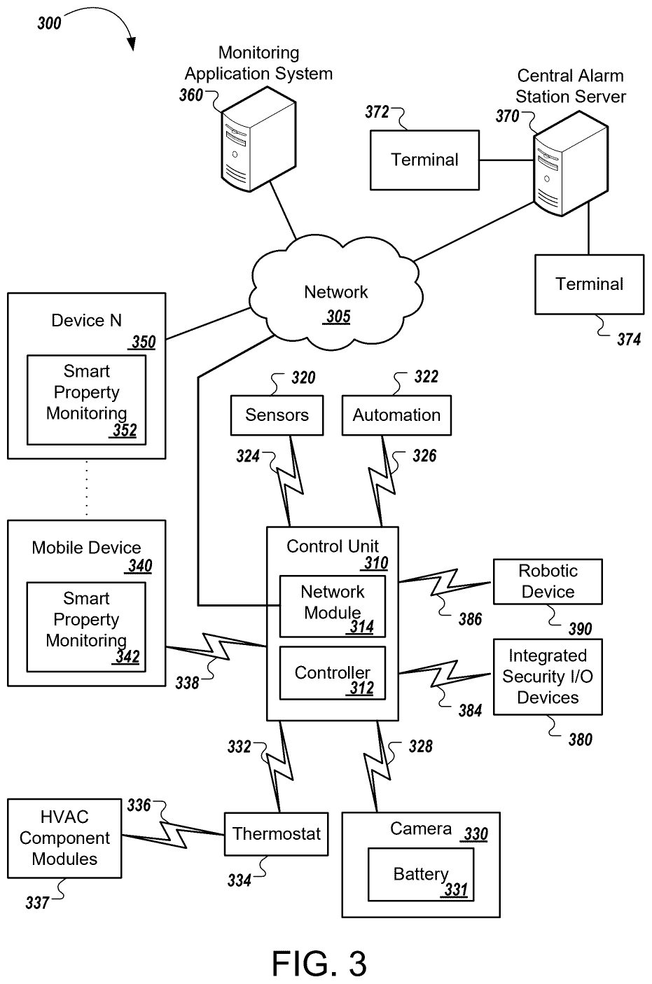

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm station server 370, or a combination of two or more of these. In some examples, the network 305 facilitates communications between two or more of the control unit 310, the one or more devices 340 and 350, the monitoring system 360, and the central alarm station server 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm station server 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, that includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicate with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The camera 330 can be controlled using commands received from the control unit 310 or another device in the property monitoring system, e.g., a device 350.

The camera 330 can be triggered using any appropriate techniques, can capture images continuous, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which sensor is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller's 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environmental, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can take actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these instances, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, the module 337, the integrated security devices 380, and the robotic devices 390, can communicate with the controller 312 over communication links 324, 326, 328, 332, 336, 338, 384, and 386. The communication links 324, 326, 328, 332, 336, 338, 384, and 386 can be a wired or wireless data pathway configured to transmit signals between any combination of the sensors 320, the module 322, the camera 330, the thermostat 334, the module 337, the integrated security devices 380, the robotic devices 390, or the controller 312. The sensors 320, the module 322, the camera 330, the thermostat 334, the module 337, the integrated security devices 380, and the robotic devices 390, can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 336, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. The monitoring system 360 is configured to provide monitoring services by exchanging electronic communications with the control unit 310, the one or more devices 340 and 350, the central alarm station server 370, or a combination of these, over the network 305. For example, the monitoring system 360 can be configured to monitor events (e.g., alarm events) generated by the control unit 310. In this example, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm station server 370. For example, the monitoring system 360 can transmit the alert data to the central alarm station server 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm station server 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm station server 370 can be configured to monitor alerting events generated by the control unit 310. In this example, the central alarm station server 370 can exchange communications with the network module 314 included in the control unit 310 to receive information regarding alerting events detected by the control unit 310. The central alarm station server 370 can receive information regarding alerting events from the one or more mobile devices 340 and 350, the monitoring system 360, or both.

The central alarm station server 370 is connected to multiple terminals 372 and 374. The terminals 372 and 374 can be used by operators to process alerting events. For example, the central alarm station server 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm station server 370 and render a display of information using the alerting data.

For instance, the controller 312 can control the network module 314 to transmit, to the central alarm station server 370, alerting data indicating that a sensor 320 detected motion from a motion sensor via the sensors 320. The central alarm station server 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A system comprising one or more computers and one or more storage devices on which are stored instructions that are operable, when executed by the one or more computers, to cause the one or more computers to perform operations comprising:
identifying two or more parameters of a robot;
maintaining, using the two or more parameters, a multi-dimensional space, each dimension of the multi-dimensional space corresponding to a parameter of the two or more parameters;
generating two or more configurations for the robot by sampling the multi-dimensional space, each configuration of the two or more configurations including values for each of the two or more parameters, at least some first values for a first configuration from the two or more configurations different from corresponding second values for a second configuration from the two or more configurations;
determining, for each of the two or more configurations, a visual inertial odometry (VIO) trajectory;
generating, for each of the trajectories using the corresponding trajectory and a ground truth trajectory, (i) error data representing a difference of the corresponding trajectory from the ground truth trajectory and (ii) processing data representing processing metrics from the determination of the corresponding trajectory;
selecting, using (i) the error data and (ii) the processing data, a configuration of the two or more configurations; and
providing, to the robot, the selected configuration for navigating an area.

2. The system of claim 1, wherein generating the two or more configurations comprises:
performing a first sampling of the multi-dimensional space;
identifying, using parameter values from the first sampling, a sub-region of the multi-dimensional space; and
performing a second sampling of the sub-region of the multi-dimensional space.

3. The system of claim 1, wherein generating the two or more configurations comprises:
converting a value of the two or more configurations to match a valid parameter type.

4. The system of claim 1, prior to generating the two or more configurations, the operations comprising:
identifying valid ranges of the multi-dimensional space within which to sample for generating the two or more configurations.

5. The system of claim 1, wherein sampling the multi-dimensional space comprises Latin hypercube sampling (LHS).

6. The system of claim 1, wherein sampling the multi-dimensional space comprises Orthogonal LHS.

7. The system of claim 6, prior to sampling the multi-dimensional space, the operations comprising:
dividing the multi-dimensional space non-uniformly.

8. The system of claim 7, wherein dividing the multi-dimensional space non-uniformly comprises:
dividing the multi-dimensional space using a logarithmic scale.

9. The system of claim 1, wherein the error data representing the difference of the corresponding trajectory from the ground truth trajectory includes one or more of Absolute Trajectory Root Mean Square Error (ATE) or Relative Pose Error (RPE).

10. The system of claim 1, wherein selecting the configuration of the two or more configurations comprises:
identifying an intersection between performance values of a first metric and performance values of a second metric, wherein the performance values of the first metric and the performance values of the second metric are generated based on determining the trajectory for each of the two or more configurations; and
selecting, from the intersection, the configuration of the two or more configurations.

11. A method comprising:
identifying two or more parameters of a robot;
maintaining, using the two or more parameters, a multi-dimensional space, each dimension of the multi-dimensional space corresponding to a parameter of the two or more parameters;
generating two or more configurations for the robot by sampling the multi-dimensional space, each configuration of the two or more configurations including values for each of the two or more parameters, at least some first values for a first configuration from the two or more configurations different from corresponding second values for a second configuration from the two or more configurations;
determining, for each of the two or more configurations, a visual inertial odometry (VIO) trajectory;
generating, for each of the trajectories using the corresponding trajectory and a ground truth trajectory, (i) error data representing a difference of the corresponding trajectory from the ground truth trajectory and (ii) processing data representing processing metrics from the determination of the corresponding trajectory;
selecting, using (i) the error data and (ii) the processing data, a configuration of the two or more configurations; and
providing, to the robot, the selected configuration for navigating an area.

12. The method of claim 11, wherein generating the two or more configurations comprises:
performing a first sampling of the multi-dimensional space;
identifying, using parameter values from the first sampling, a sub-region of the multi-dimensional space; and
performing a second sampling of the sub-region of the multi-dimensional space.

13. The method of claim 11, wherein generating the two or more configurations comprises:
converting a value of the two or more configurations to match a valid parameter type.

14. The method of claim 11, prior to generating the two or more configurations, comprising:
identifying valid ranges of the multi-dimensional space within which to sample for generating the two or more configurations.

15. The method of claim 11, wherein sampling the multi-dimensional space comprises Latin hypercube sampling (LHS).

16. The method of claim 11, wherein sampling the multi-dimensional space comprises Orthogonal LHS.

17. The method of claim 16, prior to sampling the multi-dimensional space, comprising:
dividing the multi-dimensional space non-uniformly.

18. The method of claim 17, wherein dividing the multi-dimensional space non-uniformly comprises:
dividing the multi-dimensional space using a logarithmic scale.

19. The method of claim 11, wherein the error data representing the difference of the corresponding trajectory from the ground truth trajectory includes one or more of Absolute Trajectory Root Mean Square Error (ATE) or Relative Pose Error (RPE).

20. One or more computer storage media encoded with instructions that, when executed by one or more computers, cause the one or more computers to perform operations comprising:
identifying two or more parameters of a robot;
maintaining, using the two or more parameters, a multi-dimensional space, each dimension of the multi-dimensional space corresponding to a parameter of the two or more parameters;
generating two or more configurations for the robot by sampling the multi-dimensional space, each configuration of the two or more configurations including values for each of the two or more parameters, at least some first values for a first configuration from the two or more configurations different from corresponding second values for a second configuration from the two or more configurations;
determining, for each of the two or more configurations, a visual inertial odometry (VIO) trajectory;
generating, for each of the trajectories using the corresponding trajectory and a ground truth trajectory, (i) error data representing a difference of the corresponding trajectory from the ground truth trajectory and (ii) processing data representing processing metrics from the determination of the corresponding trajectory;
selecting, using (i) the error data and (ii) the processing data, a configuration of the two or more configurations; and
providing, to the robot, the selected configuration for navigating an area.
